(19) United States
(12) Patent Application Publication
(10) Pub. No.: US 2017/0116758 A1
(43) Pub. Date: Apr. 27, 2017

(54) METHOD AND DEVICE FOR MEASURING DISTANCE USING A CAMERA

(71) Applicant: Conti Temic microelectronic GmbH, Nurnberg (DE)

(72) Inventors: Ralph Grewe, Frankfurt am Main (DE); Stefan Hegemann, Wangen (DE)

(73) Assignee: Conti Temic microelectronic GmbH, Nurnberg (DE)

(21) Appl. No.: 15/400,159

(22) Filed: Jan. 6, 2017

Related U.S. Application Data
(63) Continuation of application No. PCT/DE2015/200402, filed on Jul. 7, 2015.

(30) Foreign Application Priority Data
Jul. 7, 2014 (DE) 10 2014 213 175.8

(51) Int. Cl. G06T 7/593; B60R 11/04; G06K 9/00; G01C 11/06; G06T 7/70

(52) U.S. Cl. CPC G06T 7/593; G01C 11/06; G06T 7/70; G06K 9/00805; B60R 11/04; G06T 2207/10028; G06T 2207/10016; G06T 2207/30261; G06T 2207/30264

(57) ABSTRACT

The present disclosure relates to a device for measuring distance using a camera. The camera is movably arranged on a camera holder. A controller is designed to control a movement of the camera, in particular in a stationary state of the device, in such a manner that the camera records at least two images in at least two positions. A computing device is designed to calculate and output the distance of the device from objects visible on the images based on the at least two images. Further, the present disclosure discloses a vehicle and a method.

### CROSS REFERENCE TO RELATED APPLICATIONS

This U.S. patent application claims the benefit of PCT patent application No. PCT/DE2015/200402, filed Jul. 7, 2015, which claims the benefit of German patent application No. 10 2014 213 175.8, filed Jul. 7, 2014, both of which are hereby incorporated by reference.

### TECHNICAL FIELD

The present disclosure relates to a device and a method for measuring distance using a camera. The device may be incorporated in a vehicle.

### BACKGROUND

Today, there is a large number of applications available in which the distance between a camera and objects located in front of the camera is recorded based on camera sensors.

For example, different applications in vehicles may require such a distance measurement. For example, an application of this type may be used by a partially autonomous or autonomous driving of the vehicle, e.g., with a parking process controlled by the vehicle itself. A further application is driver assistance systems, for example, which support the driver during an emergency braking procedure. For instance, when the car is being driven in reverse, such a system may conduct an emergency brake before the driver encounters an obstacle.

It is known that radar sensors, among other types of sensors, maybe used to measure the distance between the vehicle and objects that surround the vehicle. However, sensors of this type must be installed in addition to other sensors already present in the vehicle, e.g., reverse cameras or surround view cameras, and thus increase the complexity of the vehicle electronics. This should be avoided.

However, reverse cameras or cameras in a surround view system do not enable a recording of a distance between the respective vehicle and objects that surround the vehicle, since these cameras only provide a two-dimensional image.

### SUMMARY

One aspect of the disclosure provides a device for measuring distance using a camera that is movably arranged on a camera holder. The device includes a controller designed to control a movement of the camera, for example, in a stationary state of the device, in such a manner that the camera records at least two images in at least two positions. The device also includes a computing device designed to calculate and output the distance of the device from objects visible on the images based on the at least two images.

Another aspect of the disclosure provides a vehicle with at least one device for recording distance according the previous aspect of the disclosure. The vehicle includes a vehicle control device which is coupled to the device and which is designed to control at least one vehicle function based on the distances calculated by the device.

Yet another aspect of the disclosure provides a method for measuring distances with a camera that is movably arranged on a camera holder. The method includes moving of the camera positioned on the camera holder, recording at least two of the images recorded by the camera in two different positions, and calculating distances between objects visible on the images and the camera based on the recorded images.

The disclosure overcomes the shortcomings of the Structure-From-Motion approach frequently used today, which fails to permit distance measurement when a vehicle is at a standstill.

The present disclosure consists merely of taking this new insight into account and providing a possibility in which with a single camera, the distance from objects can be recorded, even when the camera holder is not moving.

For this purpose, the present disclosure provides that the camera is movable in relation to the camera holder. If the camera holder is still, i.e., it is not moving, the camera may be moved and record at least two different images during the movement. In order to control the movement of the camera, for example, into certain positions, the controller according to the disclosure can also be used.

From the at least two images of the camera, the computing device can then determine the distance between the camera and objects located in front of the camera. This can be conducted by calculating a stereo image from the at least two images, for example.

The vehicle according to the present disclosure can, for examples, be the camera holder. Thus, it nevertheless becomes possible when a vehicle is at a standstill to record the distance between the vehicle and objects located around the vehicle based on the images of the camera.

In some examples, the camera is coupled in a rotatory manner to the camera holder, for examples, by a hinge or joint. If the camera is capable of rotational movement, the optical flow, for example, can be used to recognize objects when the camera holder does not move.

In some examples, a base width can be generated through the clever arrangement of the imager, and thus a stereo image can be produced. With the optical flow, with a vehicle at a standstill (an unmoving camera), it can be detected if something has changed in the monitored area (e.g. whether a person has entered or left the area); this will be described in greater detail below.

In some examples, the camera is coupled to the camera holder, for example, by a rail, in such a manner that it is capable of linear movement. If the camera can be moved on a straight line, a base width can be provided for stereo image processing.

In some examples, the camera is coupled to the camera holder in such a manner that the camera conducts a circular movement when the camera is moved. Alternatively, optics and an imager are arranged in the camera in such a manner that the optics and the imager conduct a circular movement when the camera conducts a rotational movement. This leads to the fact that a change of angle can be detected for objects and thus for their distance, and at the same time, a base width is provided for stereo image processing.

In one example, the controller is designed to guide the movement of the camera to at least two fixed reference points that can, for example, be calibrated in the computing device. This enables a precise determination of the position of the camera and thus an improved measurement of the distance.

In some examples, the device includes a position sensor that is designed to record a position and/or alignment of the camera and to provide it to the controller and/or computing device. This enables a precise determination of the position of the camera and thus an improved distance measurement.

In some implementations, the computing device is designed to record image fixed-location features, which are present at an installation site of the device, and to use them as reference points for a determination of the position of the camera. This enables a precise determination of the position of the camera and thus an improvement distance measurement.

In some examples, the device is arranged on a vehicle, in particular in an outside mirror of a vehicle that may be electrically folded in. Furthermore, the movement of the camera may be controlled by a movement of the outside mirror that can be electrically folded in and/or a movement of the vehicle. This enables a simple integration of the device in a vehicle or a use of cameras already present in the vehicle for the distance measurement.

In some examples, the computing device is designed to record objects in the images recorded by the camera when the camera has not been moved, based on an optical flow. This makes it possible to also recognize objects when they move, when neither the camera nor the camera holder is moved.

The above examples and further developments maybe combined with one another in any way desired. Further possible examples, further developments and implementations of the disclosure also include combinations, not explicitly named, of features of the disclosure described previously or below with reference to the examples. In particular, here, a person skilled in the art will also add individual aspects as improvements or supplements to the respective basic form of the present disclosure.

### DESCRIPTION OF DRAWINGS

The present disclosure will now be explained in greater detail below with reference to the examples given in the schematic figures of the drawings, in which:

FIG. 1 shows a block diagram of an exemplary device for measuring distance using a camera;

FIG. 2 shows a block diagram of an exemplary vehicle having a device for measuring distance using a camera;

FIG. 3 shows a block diagram of an exemplary method for measuring distance using a camera;

FIG. 4 shows a block diagram of an exemplary device for measuring distance using a camera;

FIG. 5 shows representations of a camera in different positions;

FIG. 6 shows representations of a camera in different positions;

FIG. 7 shows representations of a camera in different positions.

In all figures, the same elements and devices, or those with the same function—to the extent that no other information is provided - have been assigned the same reference numerals.

### DETAILED DESCRIPTION

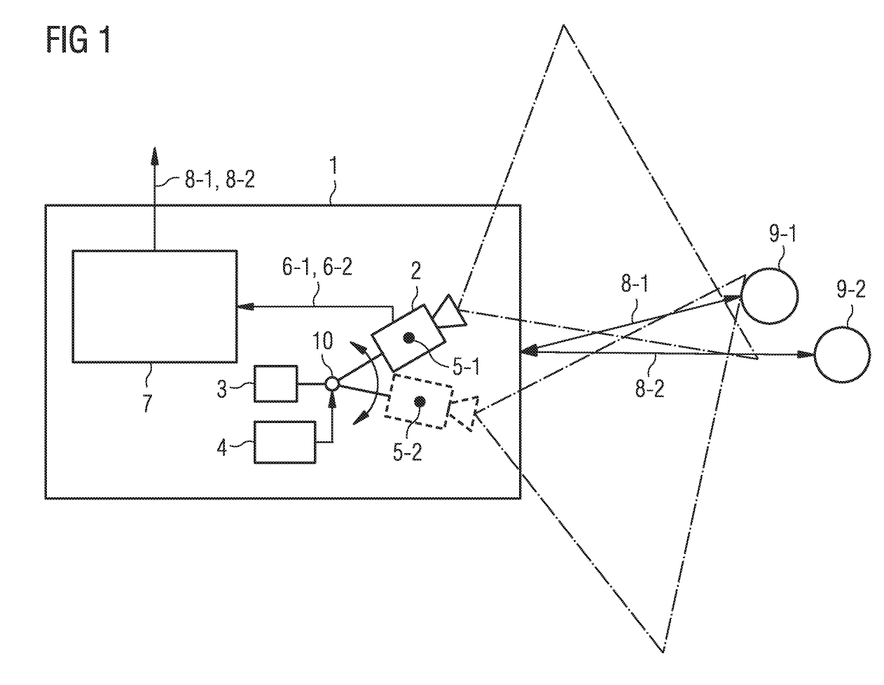

FIG. 1 shows a block diagram of an exemplary device 1 according to the disclosure. The device 1 includes a camera 2 that is shown in a first position 5-1. The camera 2 is coupled on a camera holder 3 in such a manner that it can be moved. In FIG. 1, this coupling is achieved by means of a hinge 10. The camera 2 is shown in a second position 5-2 with a broken line. Here, the camera 2 has been moved on a circular path in the second position 5-2 in relation to the first position 5-1. In order to control the movement of the camera 2, a controller 4 is provided which controls the movement of the camera 2. Further, the controller 4 may be designed to control and steer the camera 2. As a result, the controller 4 may move the camera 2 into a certain position 5-1, 5-2 and then trigger the recording of an image 6-1, 6-2.

The camera 2 then transmits the images 6-1, 6-2 recorded to a computing device 7, which is designed to determine from the images 6-1, 6-2 transmitted from the camera 2 the distance or space 8-1, 8-2 between the device 1 and objects 9-1, 9-2 visible on the images 6-1, 6-2. In FIG. 1, two objects 9-1, 9-2 are shown in front of the camera 2. Furthermore, the respective areas in front of the camera 2 are labeled by broken lines which the camera 2 can record in each of the positions 5-1, 5-2.

With continued reference to FIG. 1, only two positions 5-1, 5-2 are labeled into which the camera 2 may be moved. In some examples, however, the camera 2 may be positioned within a plurality of additional positions. Furthermore, the two objects 9-1, 9-2 located in front of the camera 2 are merely exemplary. In some examples, the content of the images 6-1, 6-2 is determined by means of the image area recorded respectively by the camera 2, and may include one or fewer objects than what is shown in FIG. 1.

In FIG. 1, the camera 2 is coupled in a rotatory manner to the camera holder 3 by the hinge 10, allowing the camera 2 to conduct a movement on a circular path. In some examples, the camera 2 can also be coupled to the camera holder 3 in a different manner. For example, the camera 2 can be coupled to the camera holder 3 in such a manner that the pivot axis of the camera 2 lies in the camera 2 itself.

In some implementations, a movable camera 2 can also be provided in that the camera 2 is firmly coupled to a movable camera holder 3. This is explained further below in connection with movable side mirrors 17, 17-1, 17-2 of vehicles 16 and similar. It is therefore not always necessary for the camera 2 itself to be movable in relation to the camera holder 3. In such an example, the camera holder 3 can be implemented as a fastening element.

If the camera 2 is movable in such a manner that it moves on a circular path, a translation movement results via which a base width between the images 6-1, 6-2 is created. This base width can be used to calculate a stereo image. In the stereo image, the distances 8-1, 8-2 to the individual objects 9-1, 9-2 can be recorded.

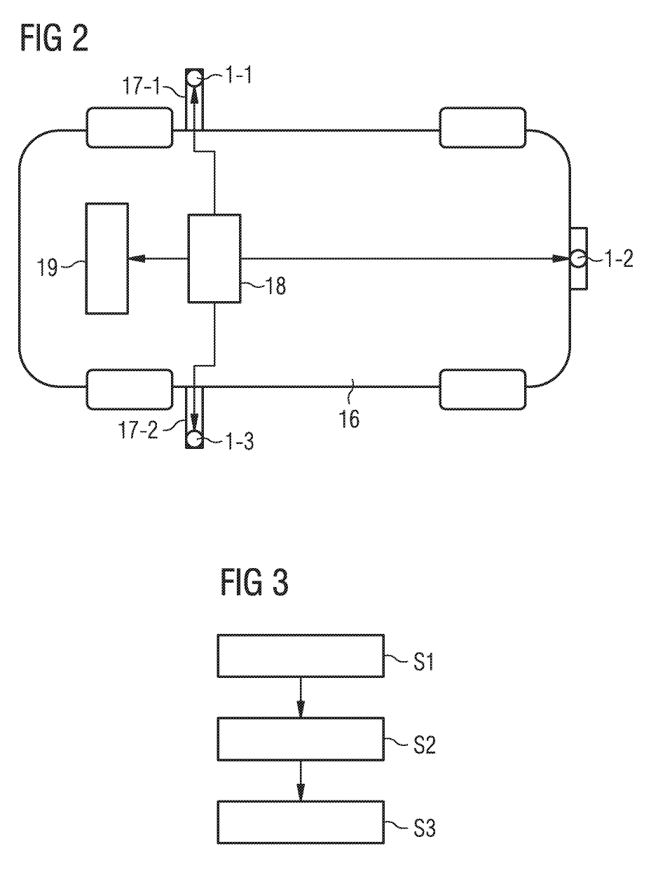

FIG. 2 shows a block diagram of an example of a vehicle 16 according to the disclosure. The vehicle 16 includes three devices 1-1, 1-2, 1-3 that can record the distance between the vehicle 16 and objects 9-1, 9-2 (not shown separately in FIG. 2).

In some implementations, the first device 1-1 is arranged in the right side mirror 17-1 of the vehicle 16. The second device 1-2 may be arranged on the rear of the vehicle 16. For example, the second device 1-2 can be integrated in a rotatable emblem, e.g., a manufacturer's emblem. Finally, the third device 1-3 may be arranged in the left side mirror 17-2 of the vehicle 16. In some examples, the three devices 1-1-1-3 are coupled to a vehicle control device 18, which controls a vehicle function 19 based on the distances 8-1, 8-2 recorded by the devices 1-1-1-3.

The side mirrors 17-1, 17-2 of the vehicle 16 in FIG. 2 may be electrically folded in. Similarly, the emblem on the rear of the vehicle 16 may also be electrically folded. Emblems of this type are used, for example, to be able to provide reverse drive cameras in vehicles, which are not visible so long as they are not needed.

The movement of the cameras 2 of the devices 1-1-1-3 may be achieved in the vehicle 16 of FIG. 2 by either folding the side mirrors 17-1, 17-2 in or by folding the emblem on the rear of the vehicle 16 over or out.

As a result, a movement of the respective cameras 2 in the devices 1-1-1-3 can be conducted by using the systems already present in the vehicle 16. The cameras 2 themselves do not need additional actuator which would need to move them.

In such examples, the camera holder 3 can also be designed as the side mirror 17-1, 17-2 or any other movable element of the vehicle 16 needed. Alternatively, in a vehicle 16 with the mirrors being not movable or able to be folded in, or which includes no movable elements, the camera 2 can be firmly coupled to the vehicle 16 and the vehicle 16 itself can be moved.

In some examples, the vehicle control device 18 includes the controller 4 and the computing device 7 of the individual devices 1-1-1-3. This enables a central control and evaluation of all cameras 2.

The vehicle control device 18 may control any vehicle function 19 needed. For example, the vehicle function 19 can be an automatic parking function with which the vehicle parks fully autonomously, i.e., without control interventions by a driver. In some examples, the vehicle function 19 is also every function in the vehicle 16 that needs data regarding the distance 8-1, 8-2 between the vehicle 16 and individual objects 9-1, 9-2.

In connection with FIG. 1 it was shown that the computing device 7 calculates the distances 8-1, 8-2 between the device 1 and the objects 9-1, 9-2. It is self-evident that the calculation of the distance may also be related to the vehicle 16. This is very simple, particularly when the geometry of the vehicle 16 is known.

FIG. 3 shows a sequence diagram of an example of a method according to the disclosure. The method provides for the movement S1 of the camera 2 on the camera holder 3. Further, in S2, at least two images 6-1, 6-2 captured by the camera 2 in two different positions are recorded. From the captured images, in S3 the distances between the objects 9-1, 9-2 visible on the images 6-1, 6-2 and the camera 2 are calculated and outputted.

In one example, the camera 2 is moved in a rotational movement. Additionally or as an alternative, the camera 2 may be moved in a linear movement. Furthermore, the camera 2 may also be moved on a circular path.

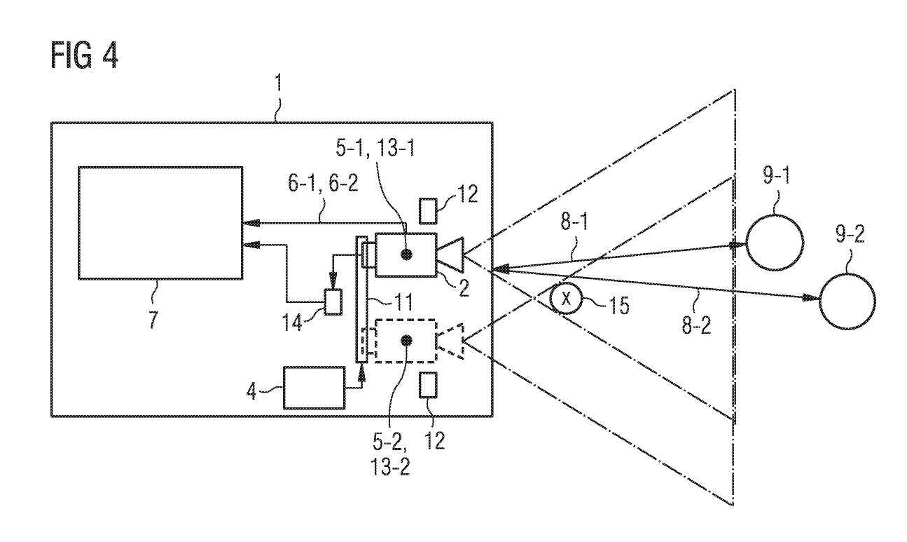

In some examples, two reference points 13-1, 13-2 (FIG. 4) are specified and in particular calibrated for the movement of the camera 2. Additionally or as an alternative, a position 5-1, 5-2 (FIGS. 1 and 4) and/or alignment of the camera 2 is recorded with a position sensor 14 when the camera 2 moves. Finally, fixed-location features 15 that are present at an installation site of the device 1 may be recorded in the images 6-1, 6-2 and used as reference points 13-1, 13-2 for determining the position of the camera 2.

FIG. 4 shows a block diagram of an example of a device 1 according to the disclosure. The device 1 in FIG. 4 is based on the device 1 in FIG. 1 and differs from the former in that the camera 2 is arranged on a rail 11 and thus conducts a linear movement. Furthermore, a holding device 12 is provided which limits the movement of the camera 2 on the rail 11 to two specified reference points 13-1, 13-2. The reference points 13-1, 13-2 correspond to the first position 5-1 and the second position 5-2. Through the holding device 12, it can be ensured that the positions 5-1, 5-2 can be precisely approached.

Further, the device 1 includes a position sensor 14 which records the position of the camera 2 and makes it available to the computing device 7. In some examples, the position sensor 14 can also make the position available to the controller 4. In some examples, either the holding device 12 or the position sensor 14 is provided.

In FIG. 4, a fixed-location feature 15 is further drawn in front of the camera 2, which serves to define a further reference point. Generally, components of the vehicle 16, for example, are located in the view of the camera 2, the position of which is precisely known. These fixed-location features 15 may be brand logos, type labels, door handles or noticeable ribbing for example. In some examples, the position of these fixed-location features 15 relative to the camera can be stored during the production of the device 1 or of the vehicle 16. Thus, further reference points may be provided for the determination of the pivot angle of the camera 2 and for example, the position sensor 14 or the holding device 12 may not be needed. In order to determine the position of these fixed-location features 15, alongside simple methods which are based on a measurement of feature points (e.g. corners), methods are in particular suitable which search the entire logo, for example, as a block and determine its position.

FIG. 5 shows representations of a camera 2 in different positions. Here, the camera 2 is attached to a side mirror 17 of a vehicle 16. The camera 2 is arranged on the outer edge of the side mirror 17. The pivot point of the side mirror 17 is on the inside edge of the side mirror 17 which is closer to the vehicle 16. The side mirror 17 is shown with unbroken lines in a folded in position. The side mirror 17 is shown with broken lines in a folded out position. Here, in this example, it lies at an angle of 90° in relation to the vehicle 16. Other angles are also possible.

In some implementations, the movement of the camera 2 or the side mirror 17 has to be large enough for the images recorded to permit a determination of the positions of objects 9-1, 9-2, in other words, for example, the calculation of a stereo image.

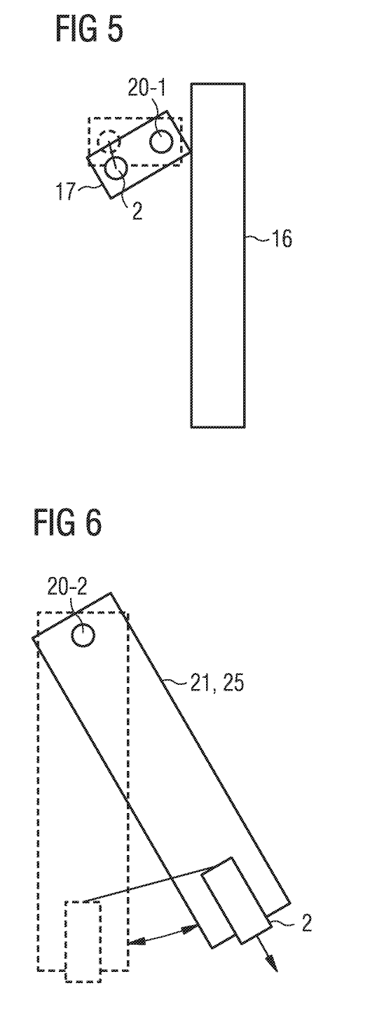

FIG. 6 shows further representations of a camera 2 in different positions. Here, the camera 2 shown in FIG. 6 is installed in a movable vehicle element 21, an emblem 25, for example, a brand emblem 25. In some vehicles 16, for example, the reverse drive cameras are folded out during parking, which are installed in an emblem 25.

In some examples, the emblem 25 includes a pivot axis 20-2 on its upper end. The camera 2 is arranged on the lower end of the emblem 25. In a non-folded out state, the emblem 25 points vertically downwards. When installed in a vehicle 16, the camera 2 disappears in this position in the body and cannot capture images 6-1, 6-2. The emblem 25 is shown in a folded out state with unbroken lines. Here, the emblem 25 is folded outwards around the pivot axis 20-2 by a specified angle. In this position and in all positions between the folded in state and the folded out state, the camera 2 can capture images 6-1, 6-2.

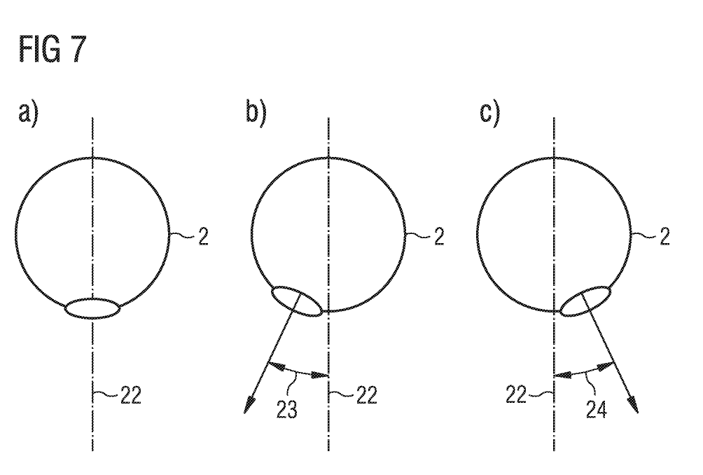

FIG. 7 shows further representations of a camera 2 which can be moved in a rotatory manner in different positions. Here, FIG. 7 shows three positions a), b) and c) of the camera 2.

With the camera 2 in FIG. 7, the pivot axis lies in the camera 2 itself. In position a), the camera 2 points along an axis 22. In position b), the camera 2 is turned to the left in relation to the axis 22 by a first angle 23. In position c), the camera 2 is turned to the right in relation to the axis 22 by a second angle 24. The camera 2 in FIG. 7 is movable in one direction or one axis. Alternatively, the camera 2 may also be movable in several axes. Through the movement of the camera 2, the optical flow may be used (Motion Stereo) in order to determine the distance between the camera 2 and objects 9-1, 9-2 located in front of the camera 2. Alternatively, a correct stereo image can be calculated on the end positions, since through the movement of the imager on a circular path, a base width is created.

A precise position of moved objects 9-1, 9-2 cannot be determined when the camera 2 is pivoted slowly. However, the inconsistencies can be detected and a conclusion may be reached regarding moved objects 9-1, 9-2. The camera 2 can be designed in such a manner that it can conduct sufficiently rapid movements, so that the moved objects 9-1, 9-2 travel almost no path in the time between two images 6-1, 6-2. As a result, a stereo image calculation is possible.

Although the present disclosure has been described above with reference to preferred examples, it is not restricted to these, but can be modified in a number of different ways. In particular, the disclosure may be altered or modified in numerous ways without deviating from the core of the disclosure.

What is claimed is:

1. A device for measuring distance, the device comprising:
a camera holder;
a camera movably arranged on the camera holder;
a controller designed to control a movement of the camera when the device is stationary, in such a manner that the camera captures at least two images; and
a computing device designed to calculate and output, based on the at least two images, the distance between the device and objects visible on the images.

2. The device of claim 1, wherein the camera is coupled in a rotatory manner to the camera holder by way of a hinge or joint.

3. The device of claim 1, wherein the camera is coupled to the camera holder by way of a rail in such a manner that it is capable of linear movement.

4. The device of claim 1, wherein:
the camera is coupled to the camera holder in such a manner that the camera conducts a circular movement when the camera is moved; and/or the camera includes optics and an imager arranged in such a manner that the optics and the imager conduct a circular movement when the camera conducts a rotational movement.

5. The device of claim 1, wherein the controller is designed to guide the movement of the camera to at least two fixed reference points calibrated in the computing device.

6. The device of claim 1, further comprising a position sensor designed to:
record a position and/or alignment of the camera; and
make the recorded position and/or alignment available to the controller and/or computing device.

7. The device of claim 1, wherein the computing device is designed to;
record fixed-location features which are present at an installation site of the device in the images; and
use the recorded fixed-location features as reference points for determining a position of the camera.

8. The device of claim 1, wherein the device is arranged in an outside mirror of a vehicle which can be electrically folded in, and the movement of the camera is controlled by a movement of the outside mirror which can be electrically folded in and/or by a movement of the vehicle.

9. The device of claim 1, wherein the computing device is designed to record objects in the images recorded by the camera when the camera has not been moved, based on an optical flow.

10. A vehicle comprising:
at least one device for measuring distance, the device comprising:
a camera holder;
a camera movably arranged on the camera holder;
a controller designed to control a movement of the camera when the device is stationary, in such a manner that the camera captures at least two images; and
a computing device designed to calculated and output the distance between the device and objects visible on the images based on the at least two images; and
a vehicle control device coupled to the at least one device and designed to control at least one vehicle function based on the distances calculated by the device.

11. A method for measuring distances with a camera movably arranged on a camera holder, the method comprising:
moving the camera or the camera holder;
recording at least two images captured by the camera in two different positions; and
calculating distances between objects visible on the images and the camera based on the recorded at least two images.

12. The method of claim 11, wherein:
the camera is moved in a rotatory movement; and/or
the camera is moved in a linear movement; and/or
the camera is moved on a circular path.

13. The method of claim 11, wherein:
two reference points are specified and calibrated for the movement of the camera; and/or
a position and/or alignment of the camera is recorded with a position sensor when the camera moves; and/or
fixed-location features present at an installation site of the device are recorded in the images, the fixed-location features used as reference points for determining the position of the camera.
